(19) United States
(12) Patent Application Publication
(10) Pub. No.: US 2009/0113616 A1
(43) Pub. Date: May 7, 2009

(54) Shower scrubber soap dispensing system

(76) Inventor: Dennis DALY, SR., Manahawkin, NJ (US)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 11/982,173

(22) Filed: Nov. 1, 2007

(51) Int. Cl. A47K 7/02; B08B 1/00; A46B 9/02; A46B 11/06

(52) U.S. Cl. 4/606; 15/104.92; 15/160; 401/42; 401/289

(57) ABSTRACT

The present invention relates to a hands-free shower scrubber and soap dispensing system. The scrubber includes an upper brush and one or more central brushes attached to a frame. The frame can be attached with suction cups to the shower wall. A pumping apparatus pumps liquid from a holding tank through a connection to the upper brush and/or the one or more central brushes. The pumping apparatus can be a pneumatic pump positioned on the floor or attached to the shower wall. The pumping apparatus can be activated by a foot, knee, hip, shoulder or other body part at a similar height to the location of the pneumatic pump.

### BACKGROUND OF THE INVENTION

1. Field of the Invention

The present invention relates to a hands-free shower scrubber including a soap dispenser.

2. Description of Related Art

Conventional back scrubbers have been used for cleaning portions of a user's body. U.S. Pat. No. 7,062,815 describes a back scrubber including a substantially U-shaped bracket and a tubular brush removably positioned within the U-shaped bracket. The brush is rotated by an internal electrical motor.

U.S. Pat. No. 6,662,386 describes a shower back scrubbing device which is installed in a wall of a shower and is connected to water power supplied to the shower head. The scrubbing device includes gear wheels attached to brushes which are rotated by the water pressure. The above-described devices are complicated to use and manufacture and are subject to a failure of the electrical motor and moving parts.

U.S. Pat. No. 6,647,564 describes a wall mountable back scrubber including a rectangular based unit that is attached to the wall with suction cups. Detachable brush pads can be attached to the back scrubber. To use, a person applies a soap or bath gel to the brush pad and leans against the pad. The above-described patents have the shortcoming that soap or bath gel has to be applied manually to the brush. In the case of a person of special needs without use of their arms or hands, this feature of applying soap to a brush cannot be accomplished without the aid of another.

It is desirable to provide an improved body scrubber providing hands free operation.

### SUMMARY OF THE INVENTION

The present invention relates to a hands-free shower scrubber and soap dispensing system. The scrubber includes an upper brush and one or more central brushes attached to a frame. The frame can be attached with suction cups to the shower wall. Preferably, the upper brush is aligned substantially horizontal with the shower wall at a height of a user's head. The central brushes are aligned substantially vertically at a height of a user's body.

A pumping apparatus pumps liquid from a holding tank through a connection to the upper brush and/or one or more of the central brushes. The pumping apparatus can be a pneumatic pump attached to the shower wall. The pumping apparatus can be activated by a knee, hip, shoulder or other body part at a similar height to the location of the pneumatic pump. Accordingly, the shower scrubber and soap dispensing system provides hands-free operation of a full torso body scrubber and is advantageous to a person of special needs.

The invention will be more fully described by reference to the following drawings.

### BRIEF DESCRIPTION OF THE DRAWINGS

FIG. 1A is a schematic diagram of shower scrubber and soap dispensing system in accordance with the teachings of the present invention.

FIG. 1B is a is a schematic diagram of shower scrubber and soap dispensing system including a holding tank adjacent a lower frame.

FIG. 2 is a side perspective view of the scrubber system shown during use.

FIG. 3 is a side cross-sectional view of the scrubber system.

FIG. 4 is a front elevational view of an upper brush and central brush during use of the scrubber system.

FIG. 5 is a schematic diagram of a pump during activation by a body part.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

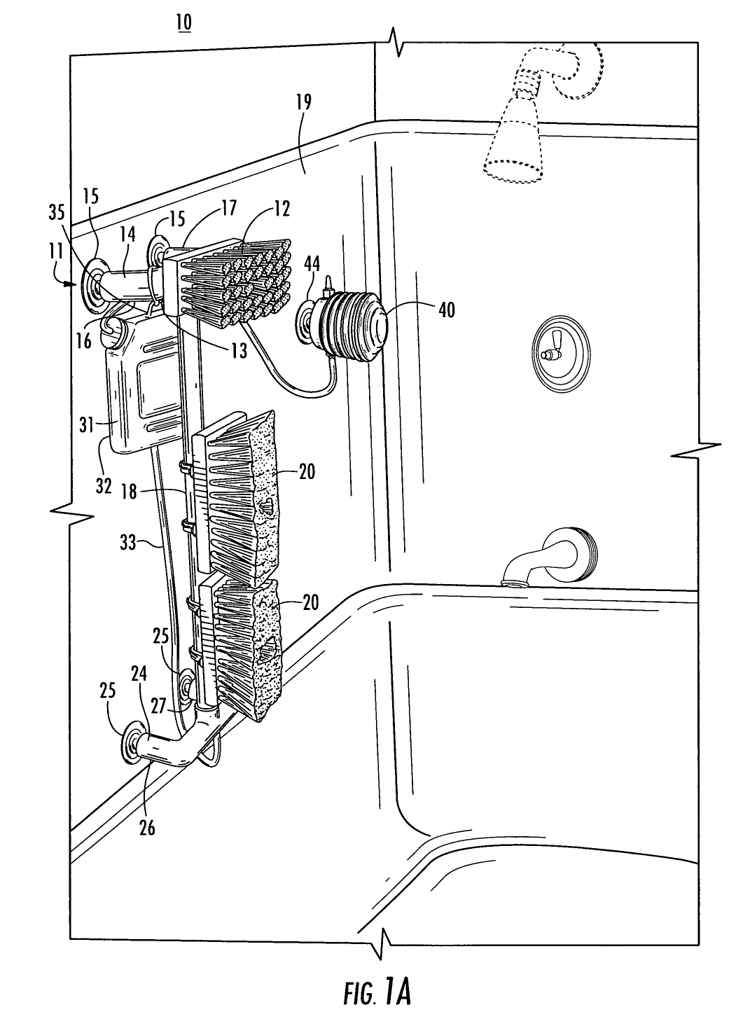

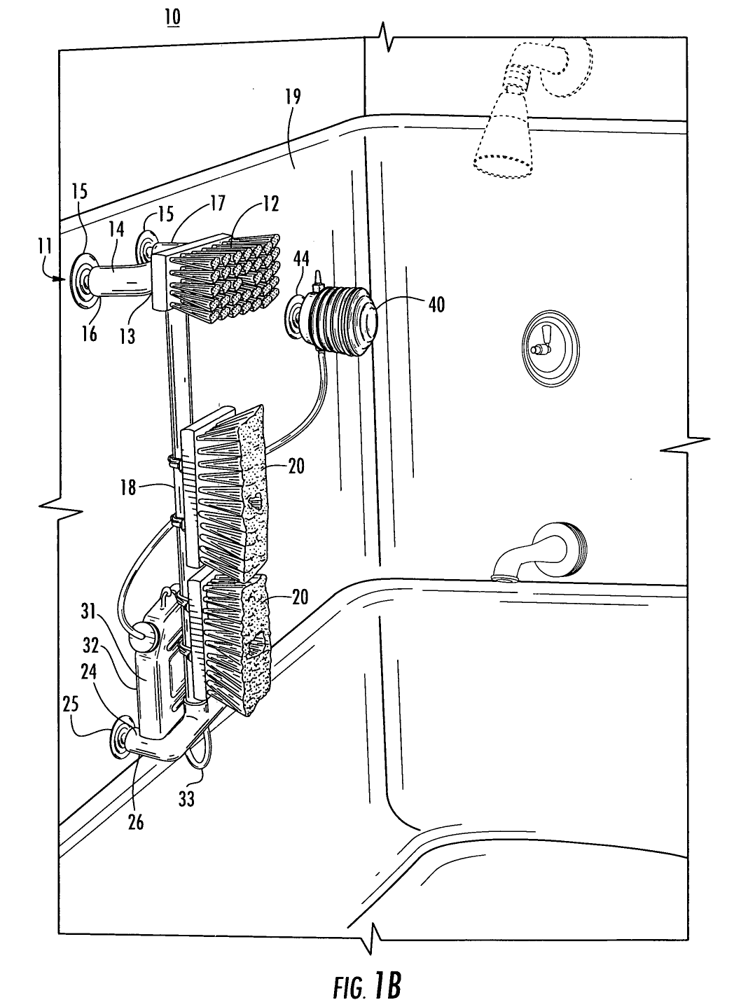

FIGS. 1A-1B are schematic diagrams of shower scrubber and soap dispensing system 10 in accordance with the teachings of the present invention. Scrubber system 11 includes upper brush 12. Upper brush 12 is removably attached to portion 13 of upper frame 14. Attachment members 15 are attached at ends 16, 17 of upper frame 14. Ends 16, 17 can make a substantially U-shape with portion 13 of upper frame 14. Attachment members 15 can be formed of suction cups for attaching to wall 19. Wall 19 can be a shower wall.

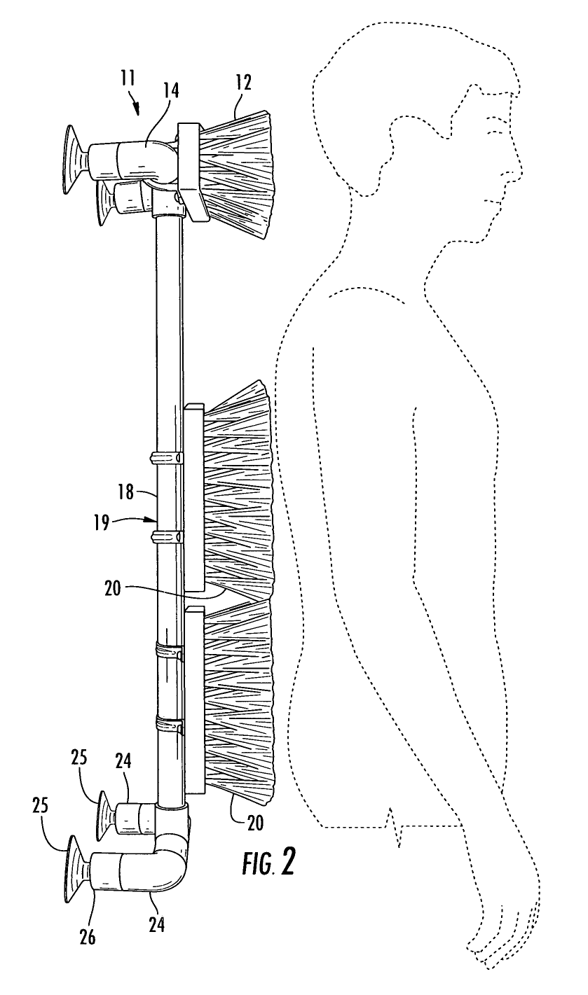

Upper brush 12 is preferably aligned horizontally with wall 19 at a height of a user's head, as shown in FIG. 2. Accordingly, upper brush 12 can be used for scrubbing a scalp of a user.

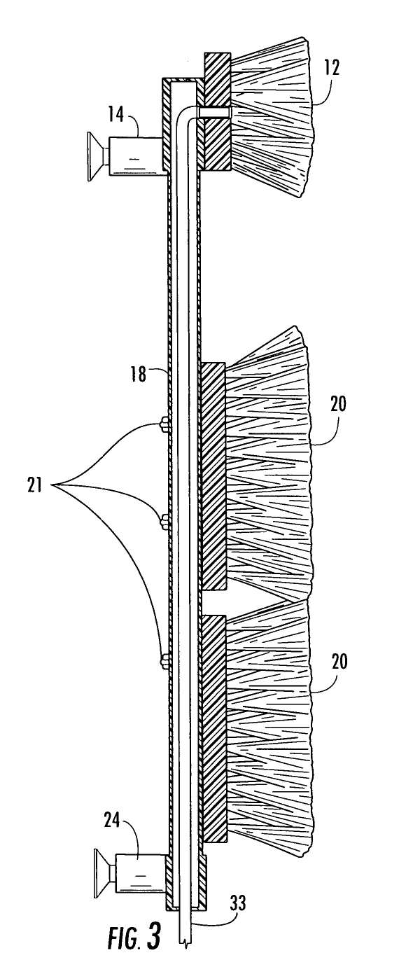

Central frame 18 extends between upper frame 14 and to one or more lower frames 24, as shown in FIG. 3. Central brushes 20 are removably attached to central frame 18 using attachment member 21. One or more central brushes 20 are preferably aligned substantially vertically with wall 19 at a height of a user's body, as shown in FIGS. 1A-1B. Accordingly, one or more central brushes 20 can be used for scrubbing a body or a user.

Attachment members 25 are attached at ends 26, 27 of lower frame 24. Ends 26, 27 can make a substantially U-shape with portion 23 of lower frame 24. Attachment members 25 can be formed of suction cups for attaching to wall 19.

Pumping apparatus 30 pumps liquid 31 from holding tank 32 through connection 33. For example, connection 33 can be plastic or rubber tubing. Liquid 31 can be liquid soap, body wash or shampoo and the like. Holding tank 32 can be coupled to upper frame 14, as shown in FIG. 1A. A suitable attachment member 35 can be a clip received over upper frame 14. Alternatively, holding tank 32 can be positioned to rest on lower frame 14, as shown in FIG. 1B.

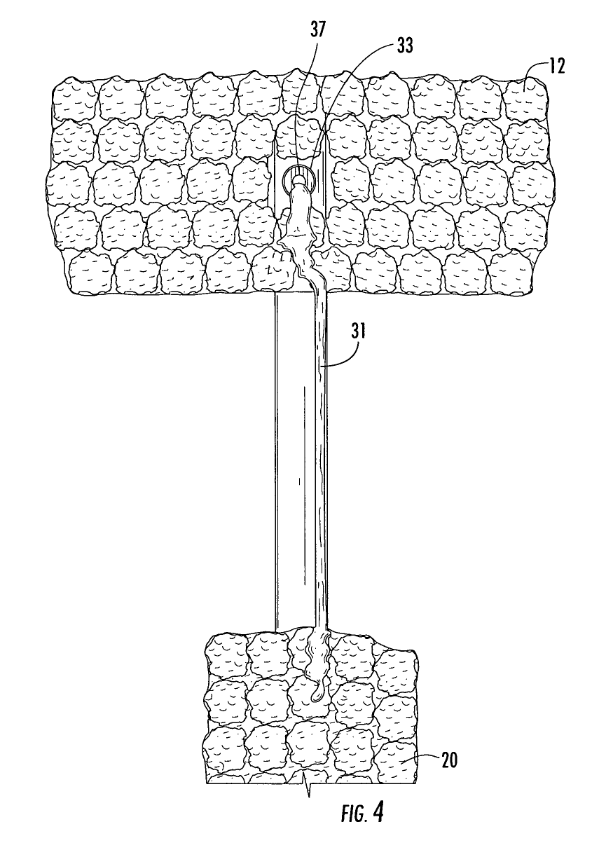

End 37 of connection 33 extends into upper brush 12, as shown in FIG. 4. Activation of pumping apparatus 30 pumps liquid 31 from holding tank 32 through connection 33 into upper brush 12. Liquid 31 can flow from upper brush 12 onto one or more central brushes 20. Alternatively, one or more additional connections can be used between pumping apparatus 30 and one or more central brushes 20 for providing direct dispensing of liquid 31 to one or more central brushes 20.

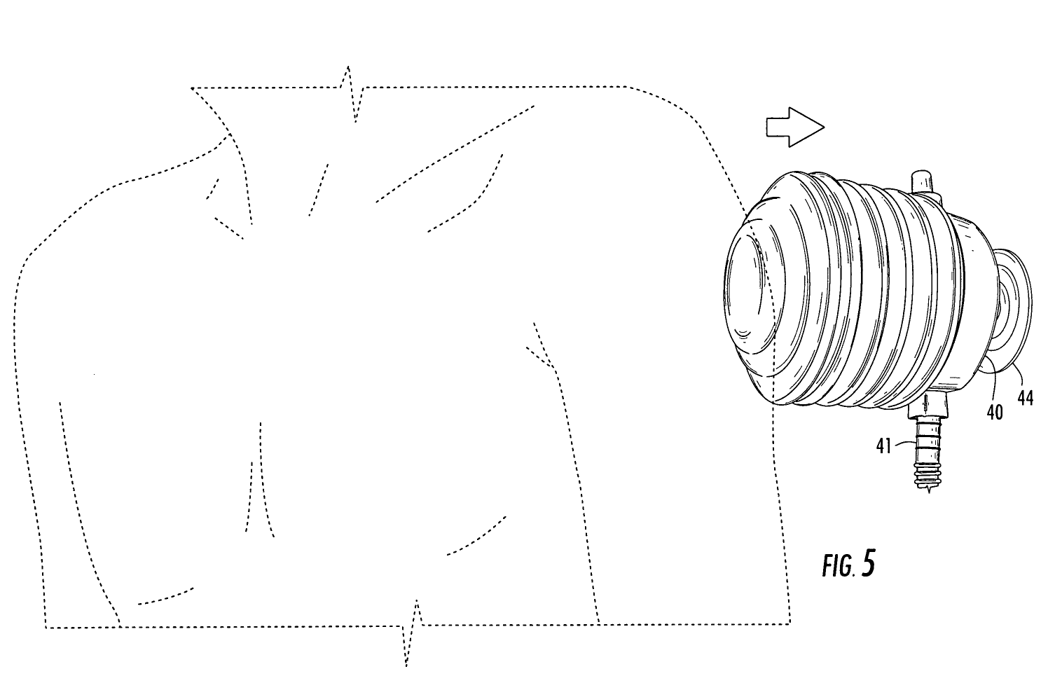

Pumping apparatus 30 can be a pneumatic system including a pneumatic pump 40. Pneumatic pump 40 can be attached with attachment member 44 to a location on wall 19. Connection 45 can be attached to connection 45 of pneumatic pump 40. A suitable pneumatic pump is a bellows pump. Activation of pneumatic pump 40 forces air through connection 45 into holding tank 32 for pumping liquid from holding tank 32 through connection 33. Pneumatic pump 40 can be activated by a body part 43, as shown in FIG. 5. Accordingly, pneumatic pump 40 can be activated by a knee, hip, shoulder or other body part at a similar height to the location of pneumatic pump 40 on wall 19. Scrubber and soap dispensing system 10 provides hands-free operation of a full torso scrubber for the front and back of a user.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A scrubber system comprising:
an upper brush removably attached to an upper frame;
one or more central brushes removably attached to a central frame, said central frame extending from said upper frame;
one or more attachment members attached to said frame, said attachment members adapted for attaching to a shower wall; and
a pumping apparatus, said pumping apparatus having a holding tank and a connection to said upper brush and/or said one or more central brushes,
wherein said pumping apparatus is adapted for pumping a liquid from said holding tank to said upper brush and/or said one or more central brushes.

2. The scrubber system of claim 1 wherein said one or more attachment members are formed of a suction cup.

3. The system of claim 1 wherein said attachment members are attached to either end of said upper frame.

4. The system of claim 3 further comprising a lower frame extending from an end of said central frame, said attachment members being attached to either end of said lower frame.

5. The system of claim 1 wherein said upper frame is adapted to be attached at a height of a user's head for attaching said upper brush adjacent said user's head and said upper brush is positioned substantially horizontally.

6. The system of claim 1 wherein said central frame is adapted to be attached at a height of a user's body for attaching said one or more central brushes adjacent said user's body and said one or more central brushes are positioned substantially vertically.

7. The system of claim 1 wherein said connection is formed of plastic or rubber tubing.

8. The system of claim 1 wherein said pumping apparatus is a pneumatic pump.

9. The system of claim 8 wherein said pneumatic pump is a bellows pump.

10. The system of claim 1 further comprising an attachment member coupled to said pump, said attachment member being adapted for attaching said pump at a predetermined height on a shower wall.

11. The system of claim 1 further comprising a second connection, said second connection connecting said pumping apparatus to said one or more central brushes.

12. The system of claim 1 wherein said scrubber system provides hands-free operation.

13. The system of claim 1 wherein said liquid is liquid soap, body wash or shampoo.

14. A method for providing scrubbing comprising the steps of:
providing an upper brush removably attached to an upper frame;
providing one or more central brushes removably attached to a central frame, said central frame extending from said upper frame;
attaching said frame to a shower wall with one or more attachment members; and
pumping a liquid from a holding tank to said upper brush and/or said one or more central brushes.

15. The method of claim 14 wherein said liquid is pumped to said upper brush and flows downwardly onto said one or more central brushes.

16. The method of claim 14 wherein said upper frame is attached at a height of a user's head for attaching said upper brush adjacent said user's head.

17. The method of claim 14 wherein said central frame is attached at a height of a user's body for attaching said central brushes adjacent said user's body.

18. The method of claim 14 wherein said pumping step is performed with a pumping apparatus, said pumping apparatus having a holding tank and a connection to said upper brush and/or said one or more central brushes,
wherein said pumping apparatus is adapted for pumping a liquid from said holding tank to said upper brush and/or said one or more central brushes.

19. The method of claim 14 wherein said connection is formed of plastic or rubber tubing.

20. The method of claim 14 wherein said pumping apparatus is a pneumatic pump.

21. The system of claim 20 wherein said pneumatic pump is a bellows pump.

22. The method of claim 14 further comprising an attachment member coupled to said pump, said attachment member being adapted for attaching said pump at a predetermined height on a shower wall.

23. The method of claim 14 further comprising a second connection, said second connection connecting said pumping apparatus to said one or more central brushes.

24. The method of claim 14 wherein said attaching step is performed with one or more suction cups.
